(19) United States
(12) Patent Application Publication
(10) Pub. No.: US 2022/0205943 A1
(43) Pub. Date: Jun. 30, 2022

(54) ELECTROCHEMICAL pH SENSOR

(71) Applicant: ANB Sensors Limited, Cambridge, Cambridgeshire (GB)

(72) Inventors: Steven A. GAHLINGS, Cambridge (GB); Nathan LAWRENCE, Hail Weston (GB)

(73) Assignee: ANB Sensors Limited, Cambridge, Cambridgeshire (GB)

(21) Appl. No.: 17/606,002

(22) PCT Filed: May 28, 2020
(86) PCT No.: PCT/EP2020/064895

§ 371 Date: Oct. 22, 2021

(30) Foreign Application Priority Data
May 28, 2019 (GB) 1907503.5

(51) Int. Cl. G01N 27/30; G01N 27/416

(52) U.S. Cl. CPC G01N 27/302; G01N 27/4167

(57) ABSTRACT

A working electrode for an electrochemical pH sensor includes a active redox species that is configured to contact a low buffering capacity/low ionic strength solution, either directly or via a polymer layer, and to generate a redox potential that depends upon the pH/hydrogen ion concentration of the solution. The active redox species comprises a 5 or a 6 member ring substituted with an oxygen group atom and a further carbon ring coupled with a hydrogen atom, the active redox species being configured to provide for hydrogen bonding between the hydrogen atom and the substituted oxygen group atom.

### BACKGROUND

Embodiments of the present application provide an electrochemical pH sensor and a method for electrochemical pH sensing using a chemistry/redox active species configured to provide for hydrogen bonding with a moiety fixed in a carbon ring.

In chemistry, pH is a numeric scale used to specify the acidity or basicity (alkalinity) of an aqueous solution. It is approximately the negative of the logarithm to base 10 of the molar concentration, measured in units of moles per liter, of hydrogen ions. More precisely it is the negative of the logarithm to base 10 of the activity of the hydrogen ion. Solutions with a pH less than 7 are acidic and solutions with a pH greater than 7 are basic. Pure water is neutral, being neither an acid nor a base.

pH measurements are important in agronomy, medicine, biology, chemistry, agriculture, forestry, food science, environmental science, oceanography, marine research, civil engineering, chemical engineering, nutrition, water treatment, water management (including water resource management and wastewater management), and water purification, as well as many other applications.

For nearly a century, pH has most commonly been measured using a glass electrode. The glass electrode is a combination electrode that combines both a glass and a reference electrode into one body. The combination electrode consists of the following parts: a sensing part of the electrode, a bulb made from a specific glass; an internal electrode, usually silver chloride electrode or calomel electrode; an internal solution, usually a pH=7 buffered solution of 0.1 mol/L KCl or 1×10⁻⁷ mol/L HCl; a reference electrode, usually the same type with a reference internal solution, usually 0.1 mol/L KCl; a junction with studied solution, usually made from ceramics or capillary with quartz fiber; and the body of electrode, made from non-conductive glass or plastics.

Glass electrodes cannot be used in many industries because of the glass electrode's fragility, the requirement that the glass electrode be regularly calibrated due to reference electrode drift, and the need for the glass electrode to be stored under appropriate conditions. As such, there has been a long-felt need for a new method of determining pH that overcomes these operational problems.

A number of chemical analysis tools are known from chemical laboratory practice. Such known analysis tools include for example the various types of chromatography, electrochemical and spectral analysis. Particularly, the potentiometric method has been widely used for the measurements of water composition both in the laboratory and in the field of ground water quality control. U.S. Pat. No. 5,223,117 discloses a two-terminal voltammetric microsensor having an internal reference using molecular self-assembling to form a system in which the reference electrode and the indicator electrode are both on the sensor electrode. The reference molecule is described as a redox system that is pH-insensitive, while the indicator molecule is pH sensitive and is formed by a hydroquinone based redox system having a potential that shifts with the pH. Both, reference molecule and indicator molecule layers are prepared by self-assembly on gold (Au) microelectrodes. In the known micro-sensor, a pH reading is derived from peak readings of the voltammograms.

Recently there has been significant work in the development of pH sensors for use in the water industry, where the concentration of dissolved buffer and/or ionic salt is low. Interest in this area stemmed from the work by Compton et al., who showed the use of classical quinone/hydroquinone voltammetry to monitor pH in these systems failed. Compton established that the proton coupled electrochemical process perturbed the pH of the solution locally to the electrode as the redox process consumes or releases protons, when little or no buffer and/or ionic salt was in the analyte solution.

To this end work by Lawrence et al. has shown that this issue can be mitigated by the use of a variety of quinone and phenol based systems, which provide a means of internal hydrogen bonding of the proton being transferred in the electrochemical process. It was shown that dihydroxyanthraquinone and alizarin were suitable for the quinone systems, where the keto moiety closest to the —OH moiety allowed the facilitation of the proton coupled electron transfer and providing a means for the reaction to follow a concerted rather than non-concerted mechanism. Further to these results it was shown that oxidation of phenol species containing moieties holding keto groups in the 2-position of the benzene ring, salicyaldehyde as an example, provided an electroactive polymer species which is pH active and able to measure pH in low buffered media, such as water. For purposes of this disclosure the terms low buffer/low buffering capacity may be used interchangeably. A variety of derivatives were tested and claimed including the aldehyde, ester and nitrogen based compounds.

As well as measuring pH in water, there is also a need to measure pH in seawater. One important reason for measuring pH in saltwater is to monitor the effects of carbon dioxide in the atmosphere on the pH of the Oceans.

Ion-sensitive field-effect transistor (ISFET) based systems offer a solution for seawater applications but often have to be deployed with salinity sensors to understand reference potentials. Optical systems are also used in seawater, but they require deployment with optical dye bags which need to be replaced periodically.

As part of its operational definition of the pH scale, the IUPAC defines a series of buffer solutions across a range of pH values (often denoted with NBS or NIST designation). These solutions have a relatively low ionic strength (˜0.1) compared to that of seawater (˜0.7), and, as a consequence, are not recommended for use in characterizing the pH of seawater, since the ionic strength differences cause changes in electrode potential. To resolve this problem, an alternative series of buffers based on artificial seawater have been developed. This new series resolves the problem of ionic strength differences between samples and the buffers, and the new pH scale is referred to as the ‘total scale’, often denoted as pHT. The total scale was defined using a medium containing sulfate ions. These ions experience protonation, H⁺+SO₄²⁻ [symbol] HSO₄⁻, such that the total scale includes the effect of both protons (free hydrogen ions) and hydrogen sulfate ions: [H⁺]=[H⁺]F+[HSO₄⁻].

Outside of water and seawater, there is a need to measure pH in low buffering capacity solutions, such as saline solutions in the medical industry, biological solutions in the pharmaceutical industry, food and beverage related solutions in the food and beverage industry, aquaculture solutions, solutions in the fish farming and hydroponic industries and the like.

### SUMMARY

Embodiments of the present disclosure relate to an electrochemical sensor and a method for detecting and monitoring pH. More specifically, but not by way of limitation, embodiments of the present disclosure provide a pH sensor capable of measuring pH in solutions with a low buffering capacity, such as water, seawater, potassium chloride (KCl) solutions, sodium chloride (NaCl) solutions, biological media, food and beverage solutions, aquaculture solutions and/or the like, using a redox active chemistry/active redox species that is configured to provide for hydrogen bonding with a moiety fixed in a carbon ring.

In embodiments of the present disclosure, the redox active chemistry provides for hydrogen bonding between a hydrogen atom attached to a carbon ring, for example as part of a hydroxyl group or the like, and an oxygen family atom substituted into a carbon ring, where the oxygen family atom may comprise oxygen, sulphur, selenium or the like.

For purposes of this application the terms “buffer capacity” and “buffering capacity” may be used interchangeably. Buffer capacity of a solution is defined as the moles of an acid or base necessary to change the pH of a solution by one (1) pH unit, divided by the pH change and the volume of buffer in liters; it is a unitless number. A buffer resists changes in pH due to the addition of an acid or base through consumption of the buffer. Solutions with a low buffer capacity include: water, seawater, saline solutions, pharmaceutical solutions—which generally have a low buffer capacity to prevent overwhelming the body's own buffer systems, biological media, which are often aqueous/saline solutions, some food and beverage solutions, aquaculture solutions and/or the like. By way of example, many solutions that contain a high percentage of water with non-active chemical species may have a low buffering capacity.

An issue with electrochemical sensors is the ability to make electrochemical measurements without a buffer and/or similar species that can facilitate proton transfer reactions, i.e. low buffer capacity solutions. Low buffer capacity/low buffer solutions essentially come in two different categories/types. The first type of low buffer capacity solution comprises a low electrolyte media/solution, such as pure water, drinking water, source water and/or the like. The second type of low buffer capacity solution comprises a high ionic strength solution media that is naturally buffered, but is unable to resist changes in local pH where proton transfer is unfacilitated, such as seawater, sodium chloride solutions, hard water, potassium chloride solutions, many pharmaceutical solutions, solutions of organic matter and/or the like.

A pH sensor is often tested and calibrated using buffer solutions, which have stable values of pH as a result of the buffer. The concentration of buffer in such a solution may be less than 0.25 molar of buffer, less than 0.2 molar of buffer, less than 0.15 molar, of buffer less than 0.1 molar of buffer or even of the order of 0.05 or 0.01 molar of buffer or less. Reference systems such as silver-silver chloride and calomel reference systems use reference solutions of sodium chloride (AgCl), potassium chloride (KCl) and/or the like that are low buffer capacity solutions. For example, the reference solutions may contain less than about 0.1 or even 0.01 molar of buffer.

In some embodiments of the present disclosure, a working electrode for an electrochemical pH sensor is provided comprising an active redox species. The working electrode is configured to generate a redox response that is sensitive to pH/hydrogen ion concentration in a low buffering capacity solution, such as water, seawater and/or the like. In embodiments of the present disclosure, the active redox species comprises an oxygen family atom bound in an ether bond in a ring structure. The ring structure in which the oxygen family atom is bound is substituted with a carbon ring, and a hydrogen atom attached to the carbon ring is configured so as to provide for hydrogen bonding with the bound oxygen family atom.

In some embodiments of the present disclosure, the oxygen family atom may comprise an oxygen atom, a sulphur atom or a selenium atom.

In some embodiments of the present disclosure, the hydrogen atom may be part of a hydroxyl group attached to the carbon ring.

In some embodiments of the present disclosure, the ring structure and/or the carbon ring may comprise an electron withdrawing or an electron donating group. An electron withdrawing group draws electrons away from a reaction center. Examples of electron withdrawing groups include: halogens (F, Cl); nitriles CN; carbonyls RCOR′; nitro groups NO2; and/or the like. An electron donating group releases electrons into a reaction center. Examples of electron donating groups include: alkyl groups; alcohol groups; amino groups; and/or the like.

In some embodiments of the present disclosure, a new set of derivatives/active redox species for the electrochemical determination of pH in unbuffered media are provided, where the derivatives/active redox species are based on the formation of hydrogen bonding through a ring structure containing a substituted member of the oxygen family. In some embodiments, ring structure containing the substituted member of the oxygen family is bound to/substituted with a phenol and the hydrogen bonding occurs between the substituted member of the oxygen family and the phenol proton. In some embodiments the ring structure may comprise a 5 or a 6 membered ring.

In some embodiments of the electrochemical pH sensor, the redox active pH sensing molecule (active redox species), in accordance with embodiments of the present application, is encapsulated into a polymer to provide enhanced stability and reproducible response to pH in a wide variety of low buffered media. This polymer species may promote proton transfer between the redox active species and the analysis media, aiding stabilization of the hydrogen bound intermediate.

Previous electrochemical pH sensors configured for operation in low buffering capacity have used oxygen that is either conjugated or part of a carbonyl to provide for hydrogen bonding with a phenol proton. Surprisingly, applicants have found that oxygen family atoms substituted in a carbon ring have more freedom of motion, such as an ability to freely rotate, compared to oxygen atoms that are either conjugated or part of a carbonyl, and this freedom of movement provides for better hydrogen bonding than previous pH chemistries. This improved hydrogen bonding provides the basis for a pH sensor for measuring pH in a low buffering capacity solution, where the pH sensor provides a more stable, more reproducible and more defined/sharper output than previous systems.

In some embodiments of the present disclosure, an oxygen atom forming the hydrogen bonding may be bound in an ether bond and, as such, is freely rotating with respect to the carbon atom with which bonding is designed to occur. It has been found that this free rotation provides for optimum hydrogen bonding with the phenol proton. In some embodiments of the present disclosure, the hydrogen bonding formation may be promoted by the fact that the ether bond forms part of a six membered ring, with a carbonyl moiety at the 4-position with respect to the ether oxygen, providing a degree of steric constraint on the positioning of the ring with respect to the phenyl ring. In some embodiments, an ether bond may form part of a five membered ring.

It has been found that groups may be added to the carbon ring containing the oxygen family member and/or the phenol to provide for changing the hydrogen bonding between the substituted oxygen family member and the phenol proton. In some embodiments of the present disclosure, the carbon ring containing the substituted oxygen family member and/or the phenol include active moieties to provide for polymerization.

In some embodiments, a working electrode comprising the active redox species, where the active redox species comprises a species configured to provide for formation of hydrogen bonding through a five (5) or a six (6) membered ring containing a substituted member of the oxygen family, may be part of an electrochemical sensor, such as a voltammetric pH sensor. In such embodiments, the working electrode comprises the redox active material that is capable of undergoing both electron and proton transfer.

By applying a potential to the working electrode, a measured potential (peak potential, half-wave potential, onset potential etc.) generated in response to the applied potential provides a measure of the pH of a solution contacting the working electrode. The measured potential being a function of the concentration of hydrogen ions in a solution being sensed, proximal to the active redox species in accordance with embodiments of the present disclosure. As stated previously, the active redox species, in accordance with embodiments of the present disclosure, is configured to generate a response that is dependent on the pH of the solution, where the solution is a low buffering capacity solution.

In tests, applicants have found that active redox species comprising a species configured to provide for formation of hydrogen bonding through a five (5) or a six (6) membered ring containing a substituted member of the oxygen family, in accordance with embodiments of the present disclosure, are capable of producing a response, redox current/potential, that corresponds to the pH of the solution where the solution has very low buffering capacity 0.05 molar buffer or less, or less than 0.01 molar buffer up to higher buffering capacity solutions, of the order of 0.2 molar buffer. While the active redox species in accordance with embodiments of the present application may produce a redox potential that corresponds to a pH of a solution with which it is contacted, the redox active species are configured to produce a redox active potential corresponding to pH of the solution in solutions with very low molar buffer, such as 0.01 molar buffer or less.

In some embodiments, the electrode potential applied to the working electrode may be swept linearly, step-wise or via a pulse technique and the current recorded. The electrochemical sensor may, in some embodiments, comprise a reference electrode that includes an inactive redox species. For example, the solution contacting the working and reference electrodes may comprise a solution with a low buffering capacity and the inactive redox species may comprise: quinone/benzoquinone, phenol based polymers, anthraquinone, napthaquinone, bare carbon, carbon with an active surface and/or the like. The low buffering capacity solution, may comprise water, a saline solution and/or the like, and the reference electrode may comprise an acidic active redox species, a basic redox species, an anthraquinone, an anthraquinone derivative, a quinone, a quinone derivative, a carbon substrate with a low volume of redox active centers derivatized thereon and/or the like.

In some embodiments, a voltammetric signal is applied to the working electrode to determine the pH of a solution. In some embodiments of the present disclosure, a reference electrode with a non-active redox species may be used as a reference potential for the working electrode. In some embodiments, the voltammetric signal may be swept between the working electrode and the reference electrode. In some embodiments, the voltammetric signal may be swept between the working electrode and a counter electrode, with voltage and/or current measured between the counter electrode and the reference electrode.

In some embodiments, where the sensor system comprises an electrochemical sensor the electrochemical sensor may comprise a plurality of working electrodes, a working electrode comprise a plurality of areas on the working electrode comprising the active redox species, in accordance with embodiments of the present disclosure.

In some embodiments of the present disclosure, the working electrode comprises an electrode substrate/conductive electrode material coupled with the active redox species, in accordance with embodiments of the present disclosure. The active redox species may be immobilized on the electrode substrate. Such immobilization may in some embodiments comprise: solvent casting the active redox species onto the electrode substrate; screen-printing the active redox species onto the electrode substrate; mixing the active redox species with a conducting powder or the like and containing the mixture in a cavity or the like in the electrode substrate; creating a paste of the active redox species and a conducting material and disposing the paste in a cavity in or on the surface of the electrode substrate; covalently bonding the active redox species with the electrode substrate; chemically and/or physically treating the surface of the electrode; and/or the like.

In some embodiments, the electrode substrate may comprise carbon, a carbon derivative and/or the like. In some embodiments, the working electrode may comprise a carbon or carbon derivative substrate with an active surface, wherein the active surface comprises the active redox species. Merely by way of example, the substrate may comprise carbon and a surface of the carbon may have been treated to create an active surface comprising redox active moieties or the like. In some embodiments, the electrode substrate may comprise a conductive material such as silver, platinum, gold and/or the like.

In some embodiments of the present disclosure, the reference electrode may comprise a chemical species (inactive redox species) that is configured to set a pH of the solution being tested. For example, the chemical species may comprise a chemical structure, moieties and/or the like that is acidic or alkaline in nature, e.g., the chemical species may comprise an acid or a base and/or comprise acidic or basic moieties. In some embodiments, the reference electrode may comprise a redox species that is configured so that a redox potential produced by the redox species does not change with changes to the solution being measured, such as changes in ion concentration, pH and/or the like.

In embodiments of the present disclosure, the active redox species comprises a redox species configured to undergo reduction/oxidation when an electronic signal is applied to the redox species, where the active redox species is sensitive to the presence of hydrogen ions.

In some embodiments, a working electrode for an electrochemical pH sensor is provided comprising an active redox species comprising an oxygen family atom bound in a ring structure, wherein the ring structure is substituted with a carbon ring, and wherein a moiety containing a hydrogen atom is attached to the carbon ring such that it is configured to provide for hydrogen bonding with the bound oxygen family atom.

In some embodiments, the active redox species of the working electrode is configured to provide an oxidation or reduction potential corresponding to a pH of a solution contacting the working electrode, wherein the solution is a low buffer capacity solution with a molar buffer of less than 0.2, 0.1, 0.05, 0.02. and/or 0.01.

In some embodiments, the oxygen family atom of the active redox species comprises an oxygen atom, a sulphur atom or a selenium atom.

In some embodiments, the hydrogen atom is part of a hydroxyl group attached to the carbon ring.

In some embodiments, the carbon ring comprises a phenol.

In some embodiments, the working electrode is part of an electrochemical sensor for measuring pH in a low buffering capacity solution, where the electrochemical sensor may comprise a reference electrode and a counter electrode. In some embodiments, the reference electrode may comprise an inactive redox species that is not sensitive to pH. In other embodiments, the reference electrode may comprise an active redox reference species that is sensitive to pH and sets the pH of the local environment of the low buffering capacity solution proximal to the reference electrode.

In some embodiments, the electrochemical sensor may comprise a potentiostat configured to sweep a voltammetric signal between the working electrode and a counter electrode so as to provide for oxidation/reduction of the active redox species on the working electrode.

In some embodiments, the active redox species on the working electrode comprises a monomeric species and a potential of the working electrode is swept oxidatively or held at a significantly oxidizing potential to initiate oxidation of the monomeric species to form electroactive dimers, trimers and/or polymers of the active redox species.

In some embodiments, the active redox species of the working electrode is encapsulated in a polymer. The encapsulating polymer may be configured to facilitate proton transfer from the working electrode/the active redox species to the bulk solution.

In some embodiments, the active redox species is incorporated into/onto a carbon composite electrode consisting of any one of, or mixture of graphite, carbon nanotubes, glassy carbon, C₆₀, conducting boron doped diamond powder or other conducting carbon materials

In some embodiments, the active redox species is screen printed onto a conducting substrate or dispersed/deposited via solvent evaporation onto a conducting substrate

### BRIEF DESCRIPTION OF THE DRAWINGS

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a series of voltammetric sweeps applied to an electrode comprising 2′-hydroxyflavanone, in accordance with some embodiments of the present disclosure.

FIG. 2 shows voltammetric responses of an electrode comprising 2′-hydroxyflavanone when placed in buffer solutions with different pH, in accordance with some embodiments of the present disclosure.

FIG. 3 shows voltammetric responses of an electrode comprising 2′-hydroxyflavanone when placed in a low buffering capacity solution where the pH of the solution is changed with the addition of an acid, in accordance with some embodiments of the present disclosure.

FIG. 4 illustrates a linear response of peak potential with pH of a solution for an electrode comprising 2′-hydroxyflavanone placed in the solution, in accordance with some embodiments of the present disclosure.

FIG. 5A illustrates repetitive square wave voltammetric response of an electrode comprising 2′-hydroxyflavanone when placed in a sea water solution, in accordance with some embodiments of the present disclosure.

FIG. 5B illustrates reductive square wave voltammetric response of 2′-hydroxyflavanone electrode when placed in varying pH solutions (IUPAC, pH 4, 7, 9 and sea water), in accordance with some embodiments of the present disclosure.

FIG. 6A illustrate the reductive square wave voltammetric response of a 2′-hydroxyflavanone electrode when placed in a standard growth tissue media and its pH varied over a wide range, in accordance with some embodiments of the present disclosure.

FIG. 6B illustrates a calibration plot of reductive peak potential as a function of pH is also given for the varied pH measured using the 2′-hydroxyflavanone electrode, in accordance with some embodiments of the present disclosure.

FIG. 7A illustrates the response of a 2′-hydroxyflavanone modified electrode, in which the 2′-hydroxyflavanone is first encapsulated in a polymer layer through solvent evaporation, in a range of sea water solutions across the pH range 8.5-6.3. FIG. 7B shows the response of pH as a function of redox potential when a number of encapsulated 2′-hydroxyflavanone modified carbon electrodes were placed in a range of seawater, IUPAC buffer standards and low buffered growth tissue media.

FIG. 8 illustrates a pH sensor comprising a working electrode including an active redox species configured to provide for hydrogen bonding with an atom of an oxygen family member fixed in a carbon ring, in accordance with some embodiments of the present disclosure.

FIG. 9 diagrammatically illustrates component parts of an electrochemical pH sensor, which may be used to measure pH, in accordance with some embodiments of the present disclosure.

FIG. 10 is a flow-type illustration of a method of measuring pH of a low buffer/low ionic strength solution using a sensor incorporating an electrode comprising an active redox species configured to provide for hydrogen bonding with an oxygen family atom fixed in a carbon ring, in accordance with some embodiments of the present disclosure.

FIG. 11 illustrates the electrochemical formation of 2′-hydroxyflavanone radicals as discussed in relation to a preferred embodiment of the present invention.

FIG. 12A illustrates the square wave voltammetry response of a flavanone electrode according to a preferred embodiment of the present invention, in sea water, in oxidative conditions.

FIG. 12B illustrates the square wave voltammetry response of a flavanone electrode according to a preferred embodiment of the present invention, in sea water, in reductive conditions.

FIG. 13 illustrates square wave voltammograms of a flavanone electrode according to a preferred embodiment of the present invention in IUPAC standard buffers and sea water.

### DESCRIPTION

The ensuing description provides some embodiment(s) of the invention, and is not intended to limit the scope, applicability or configuration of the invention or inventions. Various changes may be made in the function and arrangement of elements without departing from the scope of the invention as set forth herein. Some embodiments maybe practiced without all the specific details. For example, circuits may be shown in block diagrams in order not to obscure the embodiments in unnecessary detail. In other instances, well-known circuits, processes, algorithms, structures and techniques may be shown without unnecessary detail in order to avoid obscuring the embodiments.

Some embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure and may start or end at any step or block. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded or transmitted via any suitable means including memory sharing, message passing, token passing, network transmission, etc.

Reference will now be made in detail to embodiments, examples of which are illustrated in the accompanying drawings and figures. In the following detailed description, numerous specific details are set forth in order to provide a thorough understanding of the subject matter herein. However, it will be apparent to one of ordinary skill in the art that the subject matter may be practiced without these specific details. In other instances, well known methods, procedures, components, and systems have not been described in detail so as not to unnecessarily obscure features of the embodiments. In the following description, it should be understood that features of one embodiment may be used in combination with features from another embodiment where the features of the different embodiment are not incompatible.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step. The first object or step, and the second object or step, are both objects or steps, respectively, but they are not to be considered the same object or step.

The terminology used in the description of the disclosure herein is for the purpose of describing particular embodiments only and is not intended to be limiting of the subject matter. As used in this description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting”, depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of the present disclosure provide a new set of derivatives/active redox species for the electrochemical determination of pH. More particularly, but not by way of limitation, the derivatives/active redox species may be used in a pH sensor for use in low electrolyte media consistent with the conditions found in drinking water, source water and/or the like and/or high ionic strength media that are naturally buffered, but are unable to resist changes in local pH where proton transfer is unfacilitated. The active redox species of the present disclosure are configured to promote proton exchange at a surface of a sensing electrode of a pH sensor system such that the sensor can measure pH of low buffering capacity solutions (e.g., a solution containing of the order of less than 0.2 molar buffer, less than 0.05 molar buffer or less than 0.01 molar buffer or the like) such as water, seawater, saline solutions, pharmaceutical solutions, reference solutions, biological media, aquaculture solutions and/or the like.

In embodiments of the present disclosure, a pH sensor is provided comprising a new set of derivatives/active redox species for the electrochemical determination of pH in unbuffered/low ionic strength media. The derivatives/active redox species are configured to provide for formation of hydrogen bonding through a five or six (6) membered ring containing an oxygen family atom to hydrogen interaction. For example, in some embodiments, a carbon ring containing an oxygen family member, such as, by way of example, an oxygen or sulphur atom, is bonded with a phenol and hydrogen bonding occurs between the oxygen or sulphur atom and the phenol proton.

In embodiments of the present disclosure, the oxygen family member atom forming the hydrogen bonding is freely rotating with respect to the phenol or hydroquinone moiety, it is freely rotating because it is not conjugated with respect to the active redox species, and it is held within an ether bond.

Examples of some members of the new set of derivatives/active redox species include:

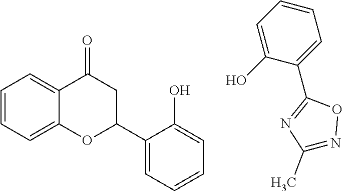 [SMILES: O=C1CC(c2ccccc2O)Oc2ccccc21 ; Cc1noc(-c2ccccc2O)n1]

However, as persons of the skill in the art will appreciate the illustrated examples show a structure with properties that can also be provided by other chemistries comprising a substituted oxygen family member in a carbon ring with a hydrogen atom coupled with a further carbon ring, where the two rings are coupled together so as to allow for hydrogen binding with the substituted oxygen family member. As such, it is not possible to provide an exhaustive list of the chemistries that produce the effect. Indeed, the molecules can be bound within a polymeric network. To date, applicant has tested a number of phenol and quinone structures having the freely rotating oxygen family atom positioned in the structure as described and have found that the chemistries provided a discernable redox output that changed with pH in low buffer capacity solutions—where most testing was done in water, seawater and biological media. The stability and response of the tested structures was found to be markedly improved on structures comprising conjugated oxygen atoms or oxygen atoms in a carbonyl structure.

In these embodiments, the oxygen atom forming the hydrogen bonding is bound in an ether bond and, as such is freely rotating with respect to the a carbon shown in the structure below.

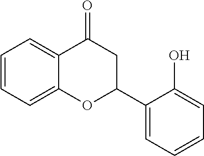 [SMILES: O=C1CC(c2ccccc2O)Oc2ccccc21]

This free rotation allows optimum hydrogen bonding with the phenol proton to occur, unlike previous redox structures where the carbonyl moiety was effectively fixed in position. In some embodiments of the present disclosure, the hydrogen bonding formation is further promoted by the fact that the ether bond forms part of a five or six membered ring, with a carbonyl moiety at the 4-position with respect to the ether oxygen providing a degree of steric constraint on the positioning of the ring with respect to the phenyl ring.

The following describes analysis performed using an example of one of the new preferred structures, 2′-hydroxyflavanone, a left hand structure of the chemistry depicted below for the determination of pH of seawater.

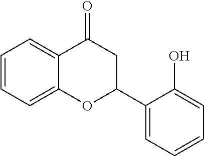 [SMILES: O=C1CC(c2ccccc2O)Oc2ccccc21]

In the analysis, all chemicals were supplied by either TCI or Sigma-Aldrich and used without further purification. The buffered solutions were made in accordance with the IUPAC standards.

Electrochemical measurements were recorded using an Anapot potentiostat (Zimmer and Peacock, UK) with a standard three-electrode configuration. A platinum wire (1 mm diameter, Good fellows) provided the counter electrode and a calomel electrode (Radiometer, Copenhagen) acted as the reference.

A carbon epoxy electrode containing a known ratio of flavanone, carbon and epoxy, acted as the working electrode. For purposes of the following description, the carbon epoxy electrode containing the flavanone derivative is referred to as the flavanone electrode.

All square wave voltammetric experiments were conducted using the following parameters: frequency=25 Hz; step potential=2 mV; and Amplitude=20 mV.

Details of the synthetic sea water are outlined below:

| Parameter | Level | Range | Units |
|---|---|---|---|
| pH | 8.3 | 8.2-8.4 | |
| dkH | 10.5 | 10-11 | |
| Calcium | 440 | 430-460 | mg/l |
| Magnesium | 1340 | 1300-1380 | mg/l |
| Chloride | 19550 | 19960-20130 | mg/l |
| Potassium | 410 | 380-420 | mg/l |

Preliminary data focused on examining the voltammetric response of the 4-hydroxyflavanone in pH 4 aqueous media. The potential range was minimized to ensure that over oxidation of the phenol species and passivation of the electrode was inhibited.

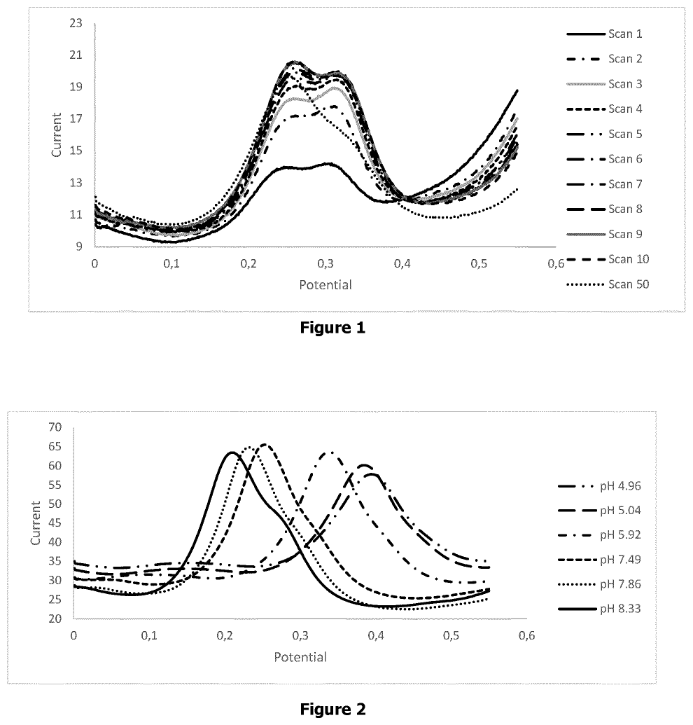

FIG. 1 details scans 1-10 and 50 of the flavanone electrode containing the 4-hydroxyflavanone when placed in the pH 4 solution. Scan 1 shows a broad oxidation wave at +0.32 V with a shoulder at +0.28 V, followed by oxidation of the phenol species shown by the high current being passed at +0.55V. The 2^{nd} scan shows the emergence of a now well-defined double wave at +0.28 and +0.31 V and a decrease in the phenol oxidation current at higher voltages, this due to the formation of an electroactive polymeric species on the electrode surface. Scans 10 and 50 show the enhancement and resolution of this new oxidation wave and the subsequent decrease of the parent phenol oxidation and the wave at +0.31V.

The oxidation waves can be attributed to the formation of a polymeric species on the flavanone electrode surface consistent with the oxidation of phenol modified derivatives. In some embodiments of the present disclosure, a pH sensor may be produced by polymerizing the active redox species on the electrode to provide for a pH sensor that produces stable responses, i.e. without the effects of polymerization.

FIG. 2 details the voltammetric response of the flavanone electrode when placed in various phosphate buffer solutions covering the range pH 4.9-8.4. In FIG. 2, it can be seen that as the pH of the solution increases, the redox wave attributed to the newly formed polymer shifts to lower potentials as the species is easier to oxidize. A plot of peak potential as a function of pH was found to be linear with a sensitivity of 50 mV/pH unit.

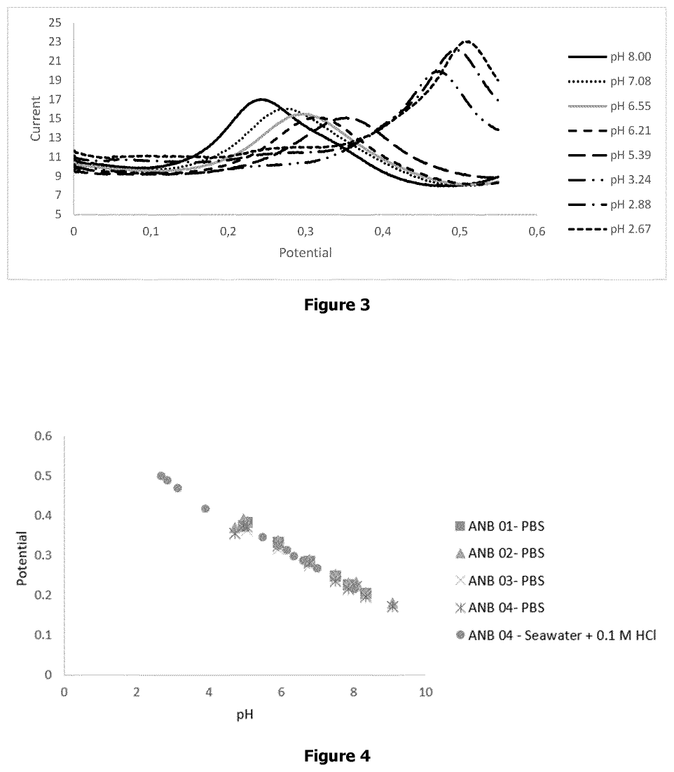

FIG. 3 shows the voltammetric response of the flavanone electrode in a low buffering capacity solution to which hydrochloric acid is added. In this test, the low buffering capacity solution was seawater. The electrodes, in accordance with some embodiments of the present disclosure, were disposed in the seawater and the hydrochloric acid was systematically added, lowering the pH. In the tests the flavanone electrode saw a pH of as low as 2.67. The peak potential produced by the flavanone electrode increased as the solution became more acidic. The response of the flavanone electrode in the low buffering capacity solution accurately matches the response of the flavanone electrode in the phosphate buffer solution (see FIG. 2) showing that the flavanone electrode provides the same response in low buffering capacity solutions as in a buffered solution. At the pH of 2.67, the peak potential was measured to be 0.51 V.

Several flavanone electrodes were tested in the phosphate buffer solutions shown in FIG. 2. To show reproducibility of the flavanone electrodes, a graph of pH versus peak potential for each of these flavanone electrodes was plotted, and this reproducibility graph is shown in FIG. 4. As can be seen in FIG. 4, the peak potentials obtained for each of the flavanone electrodes are, taking into account experimental variances, almost identical and follow the same trend.

In FIG. 4, it can be seen that the peak potentials for the flavanone electrodes tested in the phosphate buffer solutions are on the same line as the flavanone electrode tested in the low buffering capacity solution, seawater. This result establishes that the flavanone electrode is capable for use in a pH sensor and, more importantly capable of measuring pH in a low buffering capacity solution.

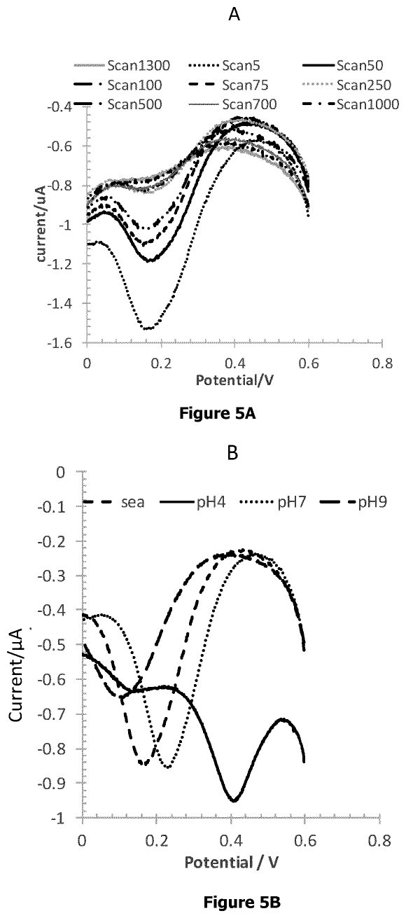

FIG. 5A details the voltametric response of a flavanone electrode having first undergone 15 repetitive reductive square wave voltammograms in pH 4 solution, placed in a sea water solution and scanned repetitively. A decay in the signal is observed with repetitive scanning. However, even after 1000 scans, the flavanone electrode still provides identifiable peaks.

FIG. 5B shows square wave voltametric response when placed in various buffered solutions and in sea water, a Nernstian response is observed across the entire pH range.

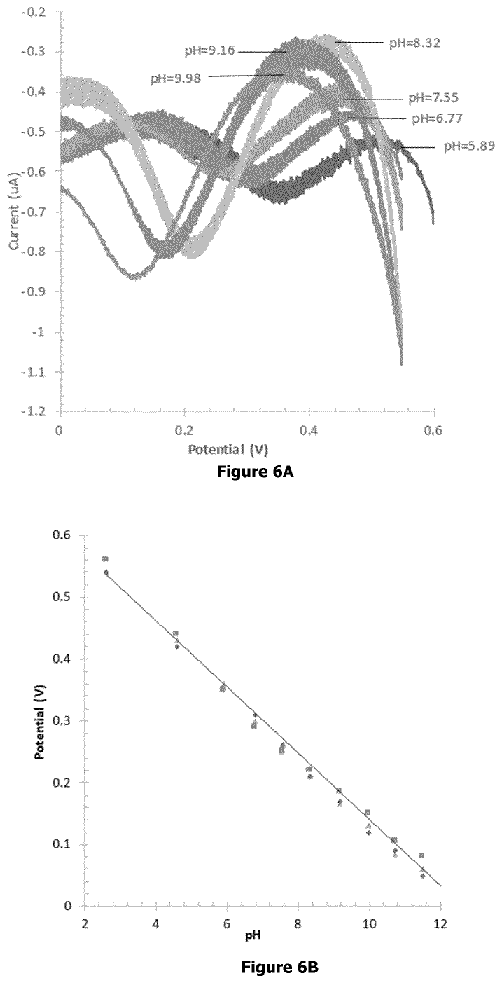

FIG. 6A shows the reductive square wave voltammetric response of 2′-hydroxyflavanone electrode, in accordance with some embodiments of the present disclosure, when placed in a tissue media, a low buffering capacity media, where the pH of the media is varied. The results are consistent with the data highlighted in FIG. 2, as the solution becomes more acidic the peak shifts to more positive potentials.

FIG. 6B illustrates a calibration plot of reductive peak potential as a function of pH of the data generated by the 2′-hydroxyflavanone electrode in the media. The linearity of the plot illustrates the ability of the 2′-hydroxyflavanone electrode to accurately measure pH in a low buffer media.

Encapsulation

Encapsulation of the flavanone into a carbon composite electrode was achieved through first mixing the flavanone with the solvent dispersed polymer and allowing the solvent to evaporate. The resulting particles were then mixed fully with carbon nanotubes to provide a uniform mix of carbon and chemicals. The resulting mixture was then added to an epoxy blend containing resin and hardener and again mixed thoroughly to ensure even distribution of the epoxy throughout. This was then packed into the insulating body and left to cure. The resulting conductive composite electrode was then ready to use.

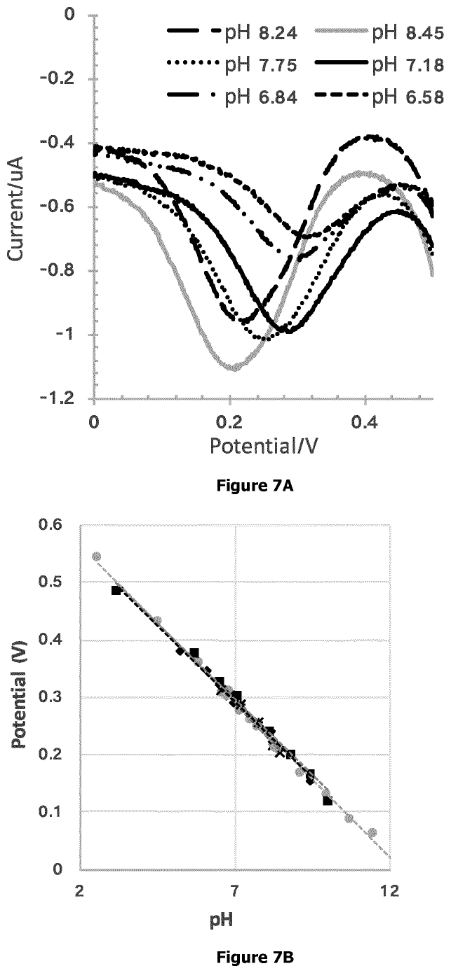

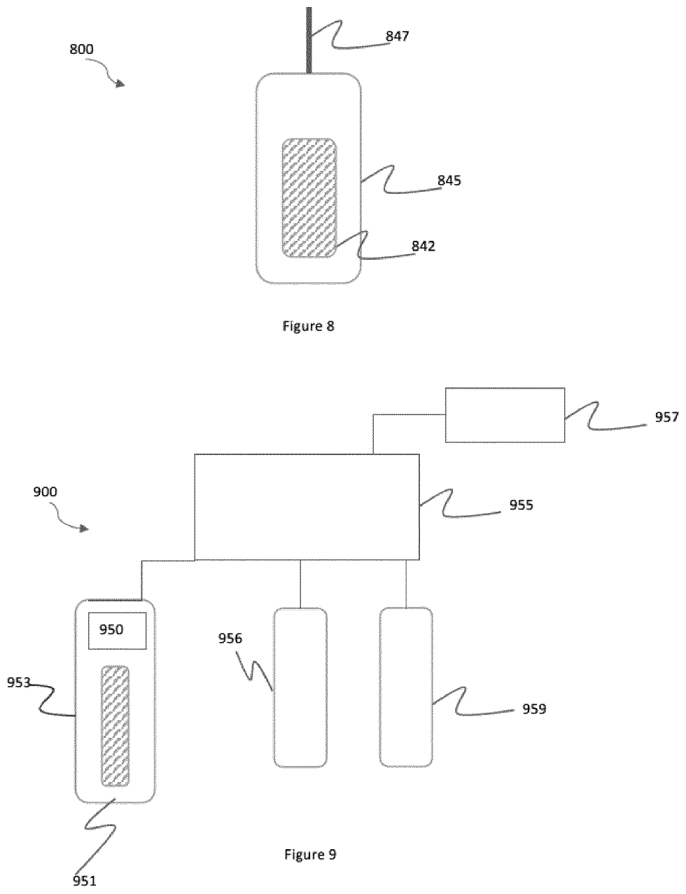

The square wave voltammetric response of the encapsulated flavanone carbon composite electrode is detailed in FIG. 7A. In this case the electrode is placed in a seawater solution and the pH of the solution is varied from 8.45-6.58. The results are consistent with the flavanone electrodes shown in FIGS. 1-6, where, as the pH is decreased the peak shifts to higher potentials. A resulting plot of pH as a function of peak potential is shown in FIG. 7B. This highlights the efficacy of the approach, as the results shown include the peak potential variation for a number of flavanone encapsulated carbon composite electrodes when placed in IUPAC buffer standards, sea waters of varying pH and low buffered growth tissue media.

FIG. 8 illustrates an electrode comprising a redox active species that includes a five or six-member ring with a substituted oxygen family member/chalcogen atom and a further five or six-member ring with an attached hydrogen atom.

The electrode 840 comprises a conductive substrate 845 coupled with a redox active species 842 comprising the five or six member ring with a substituted chalcogen atom attached to a further carbon ring coupled with a hydrogen atom, which may, by way of example comprise part of a hydroxyl group.

The electrode 840 further comprises an electrical connector 847 to provide for electronic communication with the electrode 840. The redox active species, as disclosed here, may be formed on part of the area of the conductive substrate 845. In some embodiments, a reference redox active compound, which is substantially insensitive to pH or that is sensitive to pH, but sets the pH of the local environment may be used as a reference electrode. Merely by way of example, the reference redox active compound may comprise a ferrocene, an anthraquinone and/or the like. In other embodiments, a regular reference electrode, as is well known in the art, such as a silver-silver chloride electrode or the like or other stable reference may be used as a reference for the electrochemical sensor.

The electrode may comprise a conducting/conductive substrate, which substrate may comprise: platinum, silver, graphene, carbon nanotubes, carbon, glassy carbon, graphite, diamond, boron doped diamond or the like. The conducting/conductive substrate may comprise a wire, such as a carbon or graphene wire. In some embodiments, a paste/mixture of the redox active species 842 may be formed and coupled with the electrode 840. For example, a paste/mixture of the redox active species 842 formed with carbon may be disposed in a cavity in the electrode 842. The paste/mixture may include a binder/epoxy to hold the mixture together. In other embodiments, the redox active species 842 may be polymerized on the electrode.

FIG. 9 diagrammatically illustrates component parts of an electrochemical pH sensor 950, which may be used to measure pH, in accordance with some embodiments of the present disclosure. The electrochemical pH sensor 950 comprises a working electrode 953 comprising a conductive substrate material 952 with a redox active area 951 comprising a redox active species formed of a five or six member ring with a substituted chalcogen atom attached to a further carbon ring coupled with a hydrogen atom, which may, by way of example comprise part of a hydroxyl group. The redox active area 951 may be deposited on the conductive substrate material 52, polymerized on the conductive substrate material 952, chemically coupled with the conductive substrate material 952, combined with an epoxy and a conductive substance and coupled with the conductive substrate material 952 and/or the like.

The electrochemical pH sensor 950 comprises a reference electrode 956. The reference electrode may in some embodiments comprise a conductive material with a ferrocene, anthraquinone immobilized on its surface to serve as a voltage reference. In other embodiments, the reference electrode may comprise any type of reference electrode, such as a calomel electrode, as are well known in the art.

The electrochemical pH sensor 950 may further comprises a counter electrode at 959. The electrochemical pH sensor 950 may comprises a control unit 955, such as a potentiostat or other control unit, which provides an input signal to be applied to the working electrode 953 and generates a potentiometric output of an output signal generated by the working electrode 953 to the input signal. In some embodiments, the control unit 955 may comprise a potentiostat connected to processing circuitry 957 that may control the potentiostat and process the output signal obtained by the potentiostat.

The various electrodes may be immersed in or otherwise exposed to a fluid whose pH is to be measured. The control unit 955 may comprise both a sensor and a control unit providing both electrical power and measurement. The control unit 955 may comprise apparatus such as a power supply, voltage supply, or potentiostat for applying an electrical potential to the working electrode 953 and also a detector, such as a voltmeter, a potentiometer, ammeter, resist meter or a circuit for measuring voltage and/or current and converting to a digital output, for measuring a potential between the working electrode 953 and the counter electrode 959 and/or the reference electrode 956 and for measuring a current flowing between the working electrode 953 and the counter electrode 959 (where the current flow will change as a result of the oxidation/reduction of the redox active species).

In some embodiments of the present disclosure, the control unit 955 may sweep a voltage difference across the electrodes and carry out voltammetry so that, for example, linear sweep voltammetry, cyclic voltammetry, or square wave voltammetry may be used to obtain measurements of the analyte using the electrochemical sensor. The control unit 955 may include signal processing electronics to determine peak voltage or the like.

The control unit 955 may be connected to the processing circuitry 957, which may be configured to receive current and/or voltage data. This data may be the raw data of applied voltage and the current flowing at that voltage, or may be processed data which is the voltage at peak current. The control unit 955 may be controlled by the processing circuitry 955 giving a command to start a voltage sweep and/or parameters of the sweep such as its range of applied voltage and the rate of change of applied voltage.

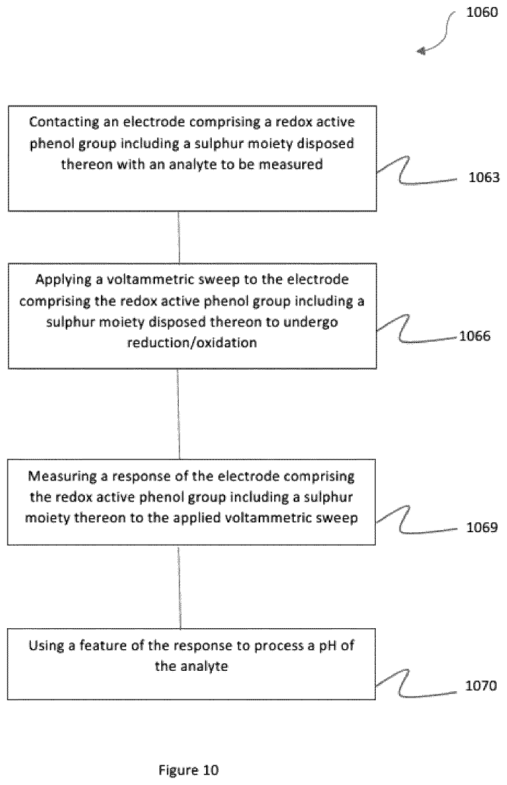

FIG. 10 is a flow type illustration of a method of measuring pH of a low buffer/ionic strength solution, in accordance with an embodiment of the present disclosure using, a redox active species comprising the a five or six member ring with a substituted chalcogen atom attached to a further carbon ring coupled with a hydrogen atom, which may, by way of example comprise part of a hydroxyl group. In accordance with embodiments of the present disclosure, the solution comprises a low buffer/low ionic strength analyte such as water, seawater, a saline solution and/or the like.

In some embodiments of the present disclosure, the redox active species is configured to provide for the formation of hydrogen bonding with a chalcogen atom substituted in either a five (5) member and/or six (6) member ring. Some embodiments of the present disclosure provide a pH sensor capable of measuring pH of drinking water, source water, salt water (seawater), saline and/or other low buffer/ionic strength liquids. As such, a sensor in accordance with embodiments of the present disclosure may be used for measuring pH of seawater for ocean monitoring research, measuring pH of water for water management, environmental purposes, measuring pH of low buffer analytes in the food and drink industry, measuring pH of low buffer analytes for medical purposes or in the pharmaceutical industry etc.

In 1063, the electrode comprising the redox active species, in accordance with embodiments of the present disclosure is contacted with a solution being measured.

In some embodiments of the present disclosure, in 1066, a potentiostat or the like may provide a voltammetric sweep to the electrode, comprising the redox active species disposed thereon, so that the redox active species undergoes reduction/oxidation in the presence of the solution being measured.

In step 1069 a response of the electrode, comprising the redox active species disposed thereon, to the applied voltammetric sweep is measured. The response of the electrode is dependent upon the concentration of hydrogen ions in the low buffer analyte interacting with the active redox species.

In step 1070 a feature of the response is processed to determine a pH of the low buffer analyte. In some embodiments, the feature may be a potential of a peak in the response. In other embodiments it may be a location of maximum change or a turning point in the response or the like.

Further tests were performed using an electrode of an additional embodiment of the invention with a 2′-hydroxyflavanone as the redox active species, herein referred to as the additional 2′-hydroxyflavanone embodiment.

Flavanones are part of the flavonoid family, and they are often found in citrus fruits. Flavonoids belong to natural phenolic antioxidants. Their antioxidant activities are related to their chemical structure. 2′-hydroxyflavanone has strong antioxidant activity due to the substitution with OH group at the 2′ position of the B-ring. The functional groups are effective for free radical scavenging activity that leads to its antioxidant abilities. The electrochemical oxidation of flavanones involves electron-proton transfer and fast hydroxylation caused by traces of water. The resulting electropolymerised layer responds to pH.

Electrochemical measurements were conducted using an Ana Pot potentiostat (Zimmer & Peacock, UK) with a standard three-electrode configuration. A carbon composite electrode according to the additional 2′-hydroxyflavanone embodiment of the present invention was used as the working electrode, a carbon counter and an Ag/AgCl (BASi, USA) acted as the reference electrode. All square wave voltammetry (SWV) was conducted using the following parameters: frequency=100 Hz, step potential=1 mV, amplitude=20 mV, no pre-treatment.

Absolute pH measurements were performed using a standard glass electrode (Sensorex, Calif., USA). Prior to the measurement of the solutions, the pH meter was calibrated using Reagecon buffers of pH 4.01±0.01, pH 7.00±0.01 and pH 10.01±0.01 (Reagecon Diagnostics Ltd., Ireland). Measurement of the pH was carried out on each freshly made solution prior to experiments. All the experiments were carried out at 20° C.±1° C.

All chemicals were purchased from Sigma-Aldrich and used without further purification (unless specified). Standard IUPAC buffer solutions (pH 4, 7, 9) were prepared as follows: pH 4.07-potassium hydrogen phthalate (0.05 M); pH 6.86-potassium dihydrogen phosphate (0.025 M) and sodium phosphate dibasic (0.025 M); pH 9.23-sodium tetraborate (0.05 M), all in deionized water (Hexeal, UK). All buffers contained 0.1 M KCl as the supporting electrolyte.

Sea water, H2Ocean Natural Reef Salt, from Maidenhead Aquatics (UK) was used in which 1 Kg of this salt was dissolved in 25 L of water. For the sea water calibrations, different concentrations of CO₂ were bubbled into a stirred sea water solution, and the corresponding pH measured using the standard glass electrode.

A carbon composite electrode according to the additional 2′-hydroxyflavanone embodiment of the present invention, used in the measurements discussed herein, comprised multi-walled carbon nanotubes (electrode substrate), 2′-hydroxyflavanone, with or without Nafion® perfluorinated resin solution, with RX771C/HY1300 epoxy resin (purchased from Robnor ResinLab Ltd) used as the binder.

The multi-walled carbon nanotube was first ground in a mortar until the powder was fine enough to mix homogeneously. ‘The pH sensitive species (2′-hydroxyflavanone) was added and ground with the carbon, in a 1:4 weight-to-weight ratio. Once the mixture was homogeneous, it was carefully mixed with the epoxy resin, to form a carbon epoxy paste.

The resulting mixture was then packed into a recess (5 mm length, 1 mm diameter) of a PEEK™ manufactured body. Electrical connection was made using a brass rod (4 cm length, 1 mm diameter). The electrode was cured, preferably at 125° C. for 1 hour, to produce the solid carbon composite electrode.

The electrochemical response of the flavanone carbon composite electrode (flay) according to the additional 2′-hydroxyflavanone embodiment of the present invention was first tested using square wave voltammetry (SWV) in sea water.

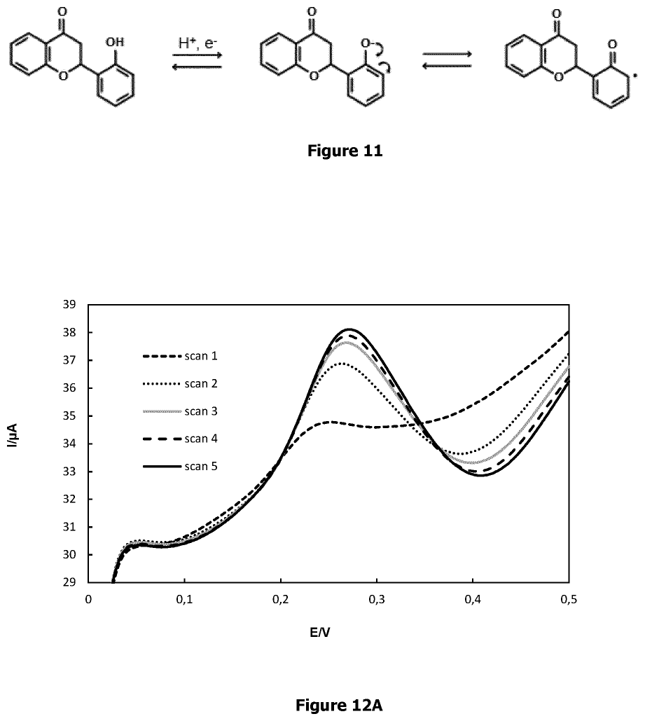

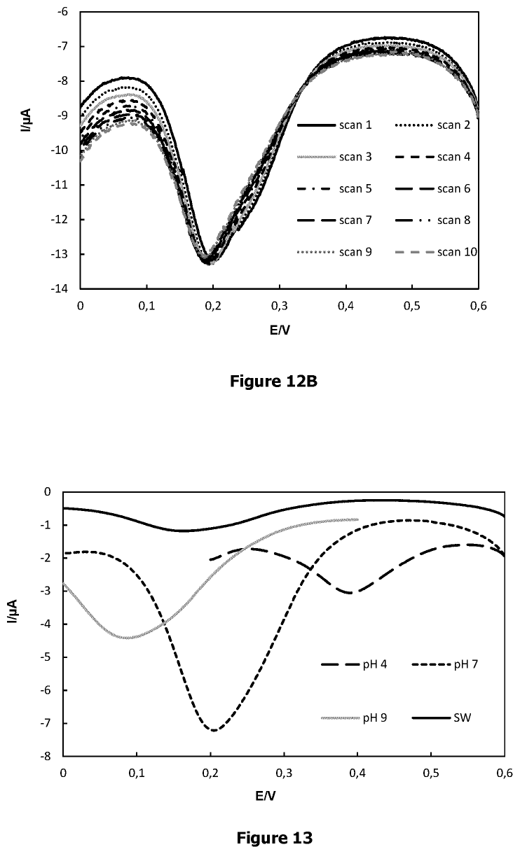

It has been shown previously that substituted phenol species such as salicylic acid can be electropolymerized to generate new redox active species. Electropolymerization involves initially the formation of oligomers followed by nucleation and growth, leading to polymeric materials. By oxidizing flavanone, the hydroxy group loses the hydrogen atom, leading to a radical, as presented in scheme 1 shown in FIG. 11. This propagating radical will react with other radicals, forming the polymer. The polymer growth is reflected in FIG. 12. FIG. 12A shows the SWV of the oxidative polymerization. Scan 1 exhibited a small oxidative wave at +0.215V, with an increase in oxidative current at the higher potentials. The second and subsequent scans showed a large increase in this oxidative peak current due to the growth in the polymeric chain, meaning that the oligomer is propagating and a subsequent decrease in the oxidative current at +0.50 V, where the oxidation of the monomeric flavanone species occurs. As the polymer is formed the peak potential shifts to +0.275 V, where it stabilizes after five scans. This corresponds to the polymer potential. FIG. 12B shows the reductive square response of the flay electrode according to the additional 2′-hydroxyflavanone embodiment of the present invention. In this case a reductive wave is observed whereby the peak potential moves from +0.197 V to +0.187 V where it stabilizes.

Next the response to pH was studied, FIG. 13 details the reductive square wave voltametric response of the polymerised flay electrode according to the additional 2′-hydroxyflavanone embodiment of the present invention, in IUPAC buffers and sea water. A clear response to pH is observed with the peak potential shifting to higher potentials as the solution pH decreases. A linear plot of peak potential with pH was observed. The sensitivity to pH of 55.1 mV/pH unit is consistent with previous data of 59.2 mV per pH unit at 25° C. for electropolymerized phenol species.

While the principles of the disclosure have been described above in connection with specific apparatuses and methods, it is to be clearly understood that this description is made only by way of example and not as limitation on the scope of the invention.

1. A working electrode for an electrochemical pH sensor, comprising:
an active redox species comprising an oxygen family atom bound in a ring structure, wherein the ring structure is substituted with a carbon ring, and wherein a moiety containing a hydrogen atom is attached to the carbon ring such that it is configured to provide for hydrogen bonding with the bound oxygen family atom.

2. The working electrode according to claim 1, wherein the active redox species is configured to provide an oxidation or reduction potential corresponding to a pH of a solution contacting the working electrode, wherein the solution is a low buffer capacity solution with a molar buffer of less than 0.25, 0.2, 0.1, 0.05, 0.02. and/or 0.01.

3. The working electrode according to claim 1, wherein the oxygen family atom comprises an oxygen atom, a sulphur atom or a selenium atom.

4. The working electrode according to claim 1, wherein the hydrogen atom is part of a hydroxyl group attached to the carbon ring.

5. The working electrode according to claim 1, wherein the carbon ring comprises a phenol.

6. The working electrode according to claim 1, wherein the ring structure comprises an electron withdrawing group or an electron donating group.

7. The working electrode according to claim 1, wherein the carbon ring comprises an electron withdrawing group or an electron donating group.

8. The working electrode according to claim 1, wherein the active redox species comprises a hydroxyflavanone.

9. The working electrode according to claim 1, wherein the active redox species comprises one of the following structures:

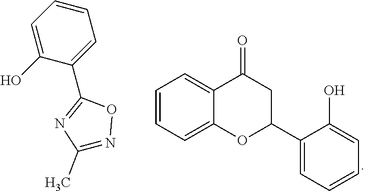

10. An electrochemical sensor for measuring pH in a low buffering capacity solution, comprising a working electrode according to claim 1.

11. The electrochemical sensor according to claim 10, further comprising:
a reference electrode; and
a counter electrode.

12. The electrochemical sensor according to claim 11, wherein the reference electrode comprises an inactive redox species that is not sensitive to pH.

13. The electrochemical sensor according to claim 11, wherein the reference electrode comprises an active redox reference species that is sensitive to pH and sets the pH of a local environment of the low buffering capacity solution proximal to the reference electrode.

14. The electrochemical sensor according to claim 11, further comprising:
a potentiostat configured to sweep a voltammetric signal between the working electrode and the counter electrode so as to provide for oxidation/reduction of the active redox species on the working electrode.

15. The electrochemical sensor according to claim 14, wherein the active redox species on the working electrode comprises a monomeric species and a potential of the working electrode is swept oxidatively or held at a significantly oxidizing potential to initiate oxidation of the monomeric species to form electroactive dimers, trimers and/or polymers of the active redox species.

16. The electrochemical sensor according to claim 10, wherein the active redox species is encapsulated in a polymer.

17. The electrochemical sensor according to claim 16, wherein the encapsulating polymer facilitates proton transfer from the working electrode to a bulk of the low buffering capacity solution.

18. The electrochemical sensor according to claim 10, wherein the active redox species is incorporated into a carbon composite electrode consisting of any one of, or mixture of graphite, carbon nanotubes, glassy carbon, C₆₀, conducting boron doped diamond powder or other conducting carbon materials.

19. The electrochemical sensor according to claim 10, wherein the active redox species is screen printed onto a conducting substrate.

20. The electrochemical sensor according to claim 10, wherein the active redox species is dispersed via solvent evaporation onto a conducting substrate.
